(19) United States
(12) Patent Application Publication
(10) Pub. No.: US 2026/0075105 A1
(43) Pub. Date: Mar. 12, 2026

(54) SERVERLESS TIEBREAKER FOR SHARED-NOTHING ARCHITECTURE

(71) Applicant: NetApp, Inc., San Jose, CA (US)

(72) Inventors: Sangramsinh Pandurang Pawar, Bedford, MA (US); Ruitao Duan, Wellesley, MA (US); Vijay Kumar Chakravarthy Ekkaladevi, Dublin, CA (US); William Derby Dallas, Merrimack, NH (US)

(73) Assignee: NetApp, Inc., San Jose, CA (US)

(21) Appl. No.: 18/962,061

(22) Filed: Nov. 27, 2024

Related U.S. Application Data
(60) Provisional application No. 63/692,096, filed on Sep. 7, 2024.

(51) Int. Cl. H04L 67/1095; H04L 67/1097

(52) U.S. Cl. CPC H04L 67/1095; H04L 67/1097

(57) ABSTRACT

Systems and methods for a serverless tiebreaker for a shared-nothing architecture are provided. In some examples, a cloud-native service that supports serialization of writes (or write fencing), for example, via atomic operations with persistent locking and/or reservations, is used to support HA mediation instead of a separate server operating as a tiebreaker, thereby reducing costs and complexity as well as increasing availability and durability of the HA mediation functionality. For example, a fast, fully managed, serverless, key-value noSQL database service (e.g., the Amazon DynamoDB) may be used to perform one or more of maintaining the authoritative source of information regarding which node of an HA pair currently represents the primary node for serving data from a particular dataset, persisting HA metadata, and/or assisting in the failover and failback processes.

### CROSS-REFERENCE TO RELATED APPLICATIONS

This application claims the benefit of priority of U.S. Provisional Application No. 63/692,096, filed on Sep. 7, 2024, which is hereby incorporated by reference in its entirety for all purposes.

### BACKGROUND

### Field

Various embodiments of the present disclosure generally relate to storage systems. In particular, some embodiments relate to use of a service (e.g., a cloud-native service) as a tiebreaker for a cluster of nodes operating as distributed storage system in a shared-nothing architecture (e.g., a non-shared HA configuration)

### Description of the Related Art

Physical or virtual nodes of storage clusters may be configured in HA pairs for fault tolerance and nondisruptive operations. In a shared nothing architecture (in which the HA partners do not share storage), one node of the HA pair may represent a primary node for serving input/output (I/O) requests from storage (e.g., a first set of one or more disks) it manages on behalf of a first set of one or more clients and the other node of the HA pair may represent a primary node for serving I/O requests from storage (e.g., a second set of one or more disks) it manages on behalf of a second set of one or more clients. As data is modified, it may be synchronously mirrored to the storage of the HA partner. In this manner, if a node of the HA pair fails or if the node is brought down for routine maintenance, its HA partner can perform a failover (or takeover) to assume the primary role of serving data on behalf of the client(s) of the failed node. A failback (or giveback) process may subsequently be performed to return the primary role of serving data on behalf of the clients(s) of the failed node after it has recovered.

Tasks including one or more of maintaining the authoritative source information regarding which node of an HA pair currently represents the primary node for serving data from a particular dataset, persisting HA metadata, and assisting in the failover and failback processes are generally referred to herein as HA mediation. In existing shared-nothing HA configurations, a third node (e.g., a tiebreaker is used for performing HA mediation.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram conceptually illustrating an example an HA pair of a storage cluster making use of a cloud service to perform HA mediation in accordance with an embodiment of the present disclosure.

FIG. 3 is a flow diagram illustrating operations performed by a node of an HA pair of a storage cluster during boot processing in accordance with an embodiment of the present disclosure.

FIG. 4 is a high-level flow diagram illustrating operations performed by a storage protocol driver in accordance with an embodiment of the present disclosure.

FIG. 5A is a table showing SCSI command to database service call translations in accordance with an embodiment of the present disclosure.

FIG. 5B is a table showing expected behavior for persistent reservation (PR) commands in accordance with an embodiment of the present disclosure.

FIG. 6 is a block diagram conceptually illustrating how mailbox disks are presented to a node of an HA pair in accordance with an embodiment of the present disclosure.

FIG. 7 is a flow diagram illustrating operations performed by an HA subsystem in accordance with an embodiment of the present disclosure.

FIG. 8 is a high-level flow diagram illustrating operations for performing failover processing in accordance with an embodiment of the present disclosure.

FIG. 9 is a high-level flow diagram illustrating operations for performing failback processing in accordance with an embodiment of the present disclosure.

FIG. 10 illustrates an example computer system in which or with which embodiments of the present disclosure may be utilized.

### DETAILED DESCRIPTION

Systems and methods are described for serverless HA mediation. As noted above, a third node (a separate server operating as a tiebreaker) is typically used to perform HA mediation when nodes of a storage cluster are configured in a shared-nothing architecture, in which the partner nodes of the HA pair each make use of separate storage that may not be accessible to the other, for example, due to the partner nodes residing in separate availability zones. As those skilled in the art will appreciate, the cost and maintenance (e.g., patching and/or updating of the operating system to address vulnerabilities) of an additional server, especially in a cloud environment in which updates to the tiebreaker may require coordination between multiple entities including, for example, the storage solution vendor and the cloud provider, is something all stakeholders would rather avoid. Such cost and maintenance is exacerbated in scenarios in which a tiebreaker node is needed for each HA pair. Additionally, relying on an additional server brings the availability service level agreement (SLA) down due to the potential for a single point of failure (SPOF). A cloud native service however are always distributed and rarely result in a SPOF.

In an effort to reduce costs and complexity as well as increase availability and durability of the HA mediation functionality, a serverless approach is proposed herein. According to various embodiments, a cloud-native service that supports serialization of writes (or write fencing), for example, via atomic operations with persistent locking and/or reservations, is used to support HA mediation. For example, as described further below, a fast, fully managed, serverless, key-value noSQL database service (e.g., the Amazon DynamoDB) or a fully managed, serverless object store service (e.g., Microsoft Azure Blob Storage) may be used to perform one or more of maintaining the authoritative source information regarding which node of an HA pair currently represents the primary node for serving data from a particular dataset, persisting HA metadata, and assisting in the failover and failback processes.

According to one embodiment, a virtual storage system operating in a shared-nothing high-availability (HA) configuration includes a first node and a second node. The first node operates in a role of a primary node responsible for serving and storing application data to/from a client of the virtual storage system from a first set of one or more cloud volumes owned by (assigned to) the first node. The second node operates in a role of a secondary node and maintains a mirror copy of application data on a second set of one or more cloud volumes owned by (assigned to) the second node. The first node periodically writes heartbeat information (or liveness information) in accordance with a first time interval (e.g., 0.5, 1.5, 2.5 seconds, etc.) to a cloud-native service within a cloud environment in which the virtual storage system is operating. The second node periodically reads the heartbeat information in accordance with a second time interval (e.g., 1, 2, 3 seconds, respectively). Based on the heartbeat information, the second node may evaluate the health status of the first node. When the second node determines the first node has failed, the second node, may perform a failover to assume the primary role in serving access requests to the application data on behalf of the client based on the mirror copy. According to one embodiment, the heartbeat information may include a timestamp representing the time at which the writing of the heartbeat information was requested or ultimately performed.

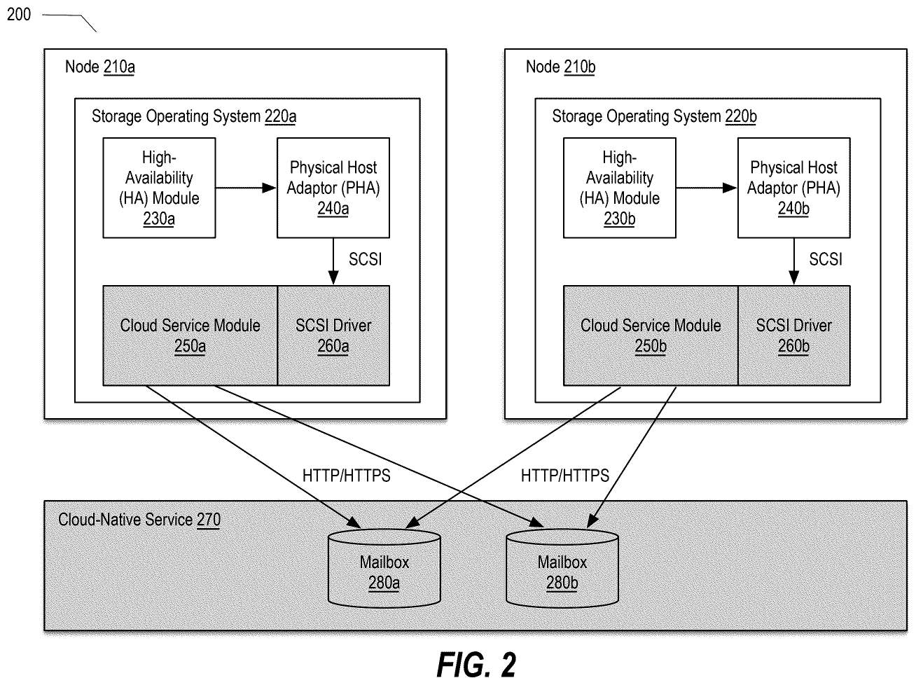

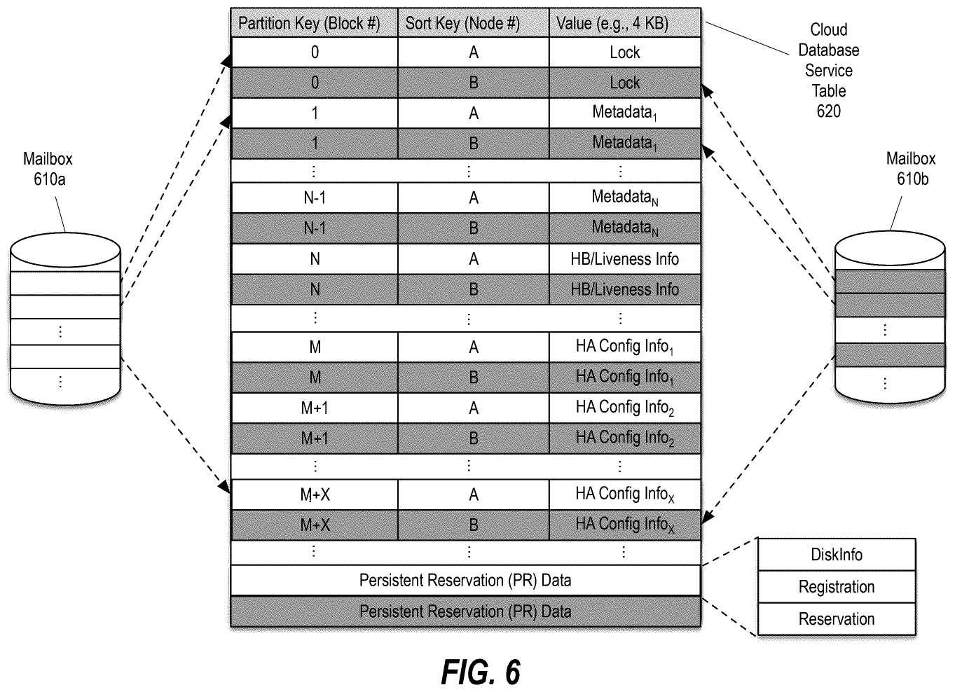

In some examples, upgrading a storage solution from a prior HA mediation approach based on the use of a separate server operating as a tiebreaker to the new serverless approach described herein may involve interposing a translation layer between a physical host adaptor (PHA) implemented within the nodes of the storage cluster and the cloud-native service so as to abstract the underlying mailbox implementation from the PHA that was previously designed to interact with a particular underlying storage device (e.g., a SCSI device) for persisting and accessing HA information. In such examples, the PHA continues to expose various portions of data in a table (e.g., the cloud database service table 620 described below with reference to FIG. 6) of a service (e.g., the cloud-native service 270 described below with reference to FIG. 2) as mailbox disks (e.g., mailbox 610a-b described below with reference to FIG. 6). In this manner, rewriting of the PHA can be avoided, thereby avoiding potential impact to other consumers (e.g., the HA subsystem, storage subsystem, etc.) of the PHA.

Various embodiments of the present technology provide for a wide range of technical effects, advantages, and/or improvements to technological processes and the functioning of computing systems. For example, various embodiments may include one or more of the following technical effects, advantages, and/or improvements: 1) efficiency of the HA architecture by reducing the number of server nodes that otherwise might be required to support HA mediation for various HA pairs; 2) increased availability and durability of HA mediation functionality, for example, due to the high uptime and durability of cloud services; and 3) ease of upgrade of a storage solution from the prior HA mediation approach to the new serverless approach, for example, including abstracting the changes from the PHA by interposing a translation layer between the PHA and the cloud-native service.

While various embodiments may be described with reference to a cloud-based storage solution in which the individual virtual storage systems of a distributed storage system run on a virtual machine (VM) or as a containerized instance, it is to be appreciated the HA mediation techniques described herein are equally applicable to on-premises storage solutions. Similarly, while some examples may be described with reference to a particular database service (e.g., the Amazon DynamoDB), it is to be appreciated a number of other cloud-native services may alternatively be used. Non-limiting examples of other suitable cloud-native services include other cloud storage services (e.g., Azure Page Blobs Storage) and in-memory data stores or cache services (e.g., Amazon ElastiCache). As noted above, in general, any service that supports serialization of writes, for example, via atomic operations with persistent locking and/or reservations, is expected to be sufficient to provide a suitable foundation for HA mediation.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, “heartbeat information” or “liveness information” generally refers to a mechanism used to communicate between nodes of an HA pair information regarding their respective functional status. In one embodiment, liveness information for a given node of an HA pair includes at least a timestamp that is periodically caused to be written by the given node to a service operable in a cloud platform that is used to support HA mediation. The timestamp may be indicative of the last time at which the service was updated by the given node. This liveness information may be used alone and/or in addition to more traditional heartbeat packets that may be exchanged between the nodes of the HA pair to determine whether to trigger a failover or a failback. In an example, besides the timestamp, other information about the given node (e.g., node state, aggregate state, network interface card (NIC) state, etc.) may be updated periodically to help the control plane make decisions.

As used herein, a “tiebreaker” or “mediator” generally refers to a component of an HA configuration that monitors the health of HA partners and aids in determining which node should become active in the event of a failure, thereby preventing data corruption scenarios.

As used herein a “mailbox” generally refers to a storage area used by a tiebreaker or by the nodes of an HA pair to store metadata and control information that facilitates managing failover processing and maintaining system integrity.

As used herein a “persistent reservation” generally refers to a feature that allows multiple nodes in a cluster to access a shared storage (e.g., a shared storage device or mailbox disk) while preventing other nodes from accessing it simultaneously. According to one embodiment, persistent reservations are performed in accordance with the SCSI-3 Primary Commands specification (i.e., International Organization for Standardization (ISO)/Technology Executive Committee (IEC) 14776-453: SCSI Primary Commands-3 (SPC-3)), which is currently available for download at https://www.t10.org/ftp/t10/document.08/08-309r0.pdf and is hereby incorporated by reference in its entirety for all purposes. Persistent reservations may be persisted even if the bus is reset for error recovery. In one embodiment, persistent reservations are set using the SCSI Persistent Reserve Out and Persistent Reserve IN commands.

### Example Operating Environment

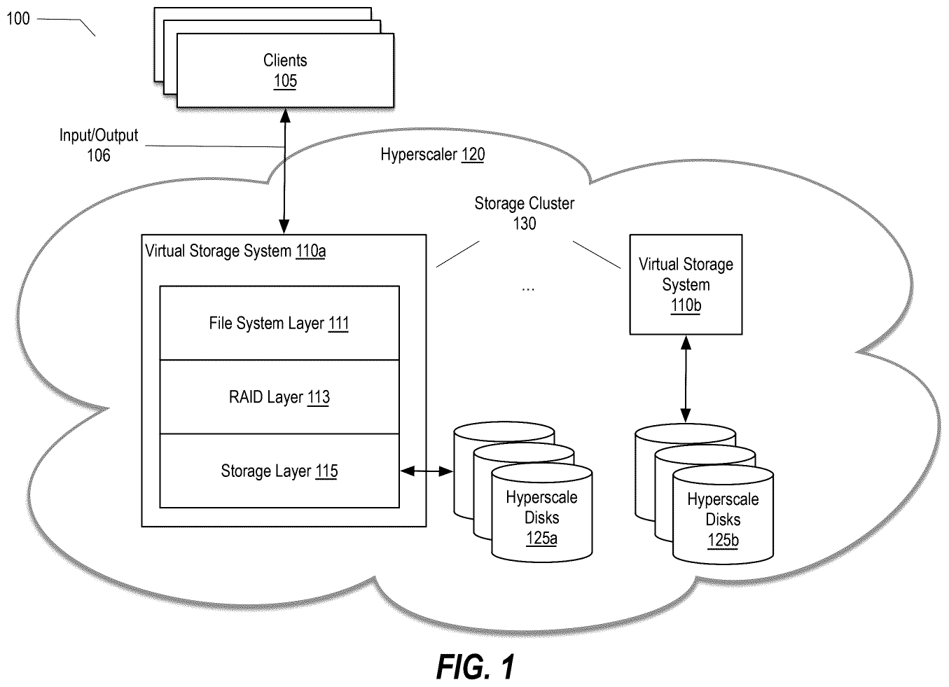

FIG. 1 is a block diagram illustrating an environment 100 in which various embodiments may be implemented. In various examples described herein, a virtual storage system 110a, which may be considered exemplary of all nodes of a distributed storage system (e.g., storage cluster 130) may be run (e.g., on a VM or as a containerized instance, as the case may be) within a public cloud provided by a public cloud provider (e.g., hyperscaler 120). One or more of virtual storage systems 110a-b may be configured to operate as a cluster representing a distributed storage system. In one embodiment, a given pair of nodes (e.g., virtual storage system 110a and 1011b) may operate in a shared-nothing architecture (e.g., a non-shared HA configuration). As shown, in a shared-nothing architecture, the nodes (virtual storage system 110a and 110b) of the storage cluster 130 do not share storage. Rather, each node is assigned (or owns) its own separate storage (e.g., hyperscale disks 125a and 125b, respectively). In the context of the present example, virtual storage system 110a may represent a primary node for serving input/output (e.g., input/output (I/O) 106) for one or more clients 105 from hyperscale disks 125a and virtual storage system 110b may represent a secondary node for serving I/O requests from the one or more clients from hyperscale disks 125b, in which data modified by clients 105 on hyperscale disks 125a is synchronously mirrored to the storage (e.g., hyperscale disks 125b) of the HA partner. In some examples, in order to reduce the potential for concurrent failure of virtual storage systems 110a-b, the storage cluster 130 may be deployed in a multizone HA configuration in which virtual storage system 110a may be in one availability zone (fault domain) of the cloud provider and virtual storage system 110b may be in another availability zone (fault domain) of the cloud provider.

In the context of the present example, virtual storage system 110a makes use of storage in the form of hyperscale disks 125a provided by the hyperscaler 120, for example, representing solid-state drive (SSD) backed and/or hard-disk drive (HDD) backed disks. Similarly, virtual storage system 110b makes use of storage in the form of hyperscale disks 125b provided by the hyperscaler 120, for example, representing SSD-backed and/or HDD-backed disks. The cloud disks (which may also be referred to herein as cloud volumes, storage devices, or simply volumes or storage) may include persistent storage (e.g., disks) and/or ephemeral storage (e.g., disks).

The virtual storage systems 110a-b may present storage over a network to clients 105 using various protocols (e.g., small computer system interface (SCSI), Internet small computer system interface (iSCSI), fibre channel (FC), server message block/common Internet file system (SMB/CIFS), network file system (NFS), hypertext transfer protocol (HTTP), web-based distributed authoring and versioning (WebDAV), or a custom protocol. Clients 105 may request services of the storage cluster 130 by issuing I/O requests 106 (e.g., file system protocol messages (e.g., in the form of packets) over the network). A representative client of clients 105 may comprise an application, such as a database application, executing on a computer that “connects” to the storage cluster 130 over a computer network, such as a point-to-point link, a shared local area network (LAN), a wide area network (WAN), or a virtual private network (VPN) implemented over a public network, such as the Internet.

In the context of the present example, the virtual storage system 110a is shown including a number of layers, including a file system layer 111 and one or more intermediate storage layers (e.g., a redundant array of independent disks (RAID) layer 113 and a storage layer 115). These layers may represent components of data management software or storage operating system (not shown) of the virtual storage system 110a. The file system layer 111 generally defines the basic interfaces and data structures in support of file system operations (e.g., initialization, mounting, unmounting, creating files, creating directories, opening files, writing to files, and reading from files). A non-limiting example of the file system layer 111 is the Write Anywhere File Layout (WAFL) Copy-on-Write file system (which represents a component or layer of ONTAP software available from NetApp, Inc. of San Jose, CA).

The RAID layer 113 may be responsible for encapsulating data storage virtualization technology for combining multiple hyperscale disks 125 into RAID groups, for example, for purposes of data redundancy, performance improvement, or both. The storage layer 115 may include storage drivers for interacting with the various types of hyperscale disks 125 supported by the hyperscaler 120. Depending upon the particular implementation the file system layer 111, it may persist data to the hyperscale disks 125a using one or both of the RAID layer 113 and the storage layer 115.

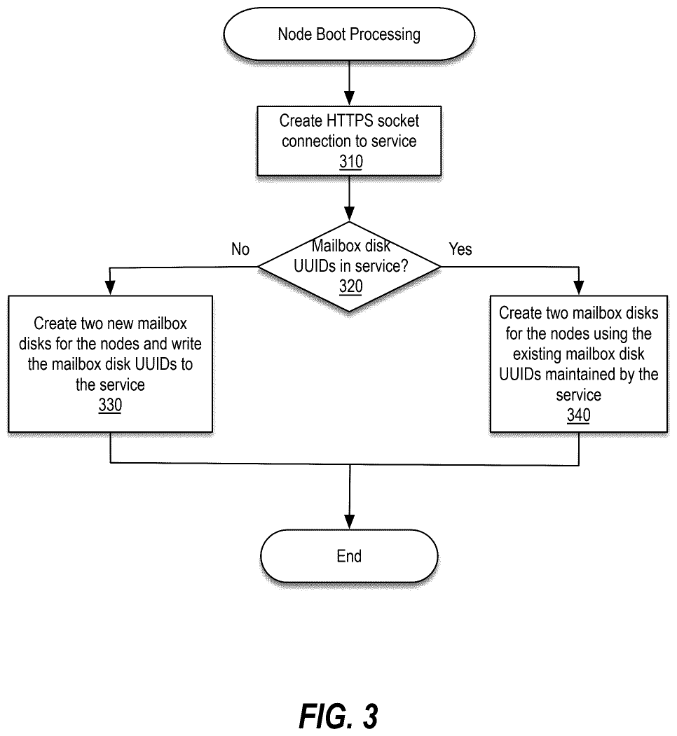

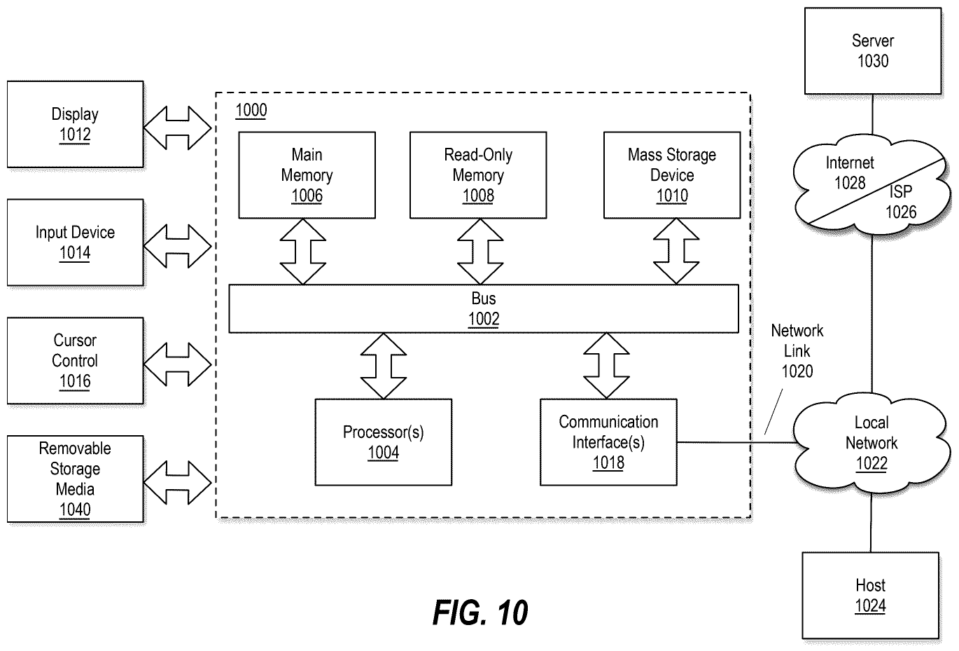

The various layers described above, the modules, drivers, and the like described below with reference to FIG. 2, and the processing shown and described with reference to the flow diagrams of FIGS. 3-5 and FIGS. 7-9 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms (e.g., hosts, servers, blades, network storage systems or appliances, and storage arrays, such as the computer system described with reference to FIG. 10 below.

### Example HA Pair of a Storage Cluster

FIG. 2 is a block diagram conceptually illustrating an example an HA pair 200 of a storage cluster (e.g., storage cluster 130 making use of a cloud service to perform HA mediation in accordance with an embodiment of the present disclosure. In this example, the storage cluster is shown including two nodes 210a and 210b (the HA pair 200), which may be analogous to virtual storage systems 110a and 110b, and which may be operating in a shared-nothing architecture.

The storage operating systems 220a and 220b of nodes 210a and 210b may each include an HA module (e.g., HA module 230a and 230b), a physical host adaptor (PHA) (e.g., PHA 240a and 240b), a cloud service module (e.g., cloud service module 250a and 250b), and a storage protocol driver (e.g., SCSI driver 260a and 260b). In the context of the present example, rather than requiring a third node (e.g., a separate server operating as a tiebreaker) to facilitate performance of various HA mediation functionality, a serverless HA mediation mechanism is provided in the form of a service (e.g., cloud-native service 270).

The storage operating system may be an operating system descended from the Berkeley Software Distribution (BSD). For example, the storage operating system may represent a modified version of FreeBSD.

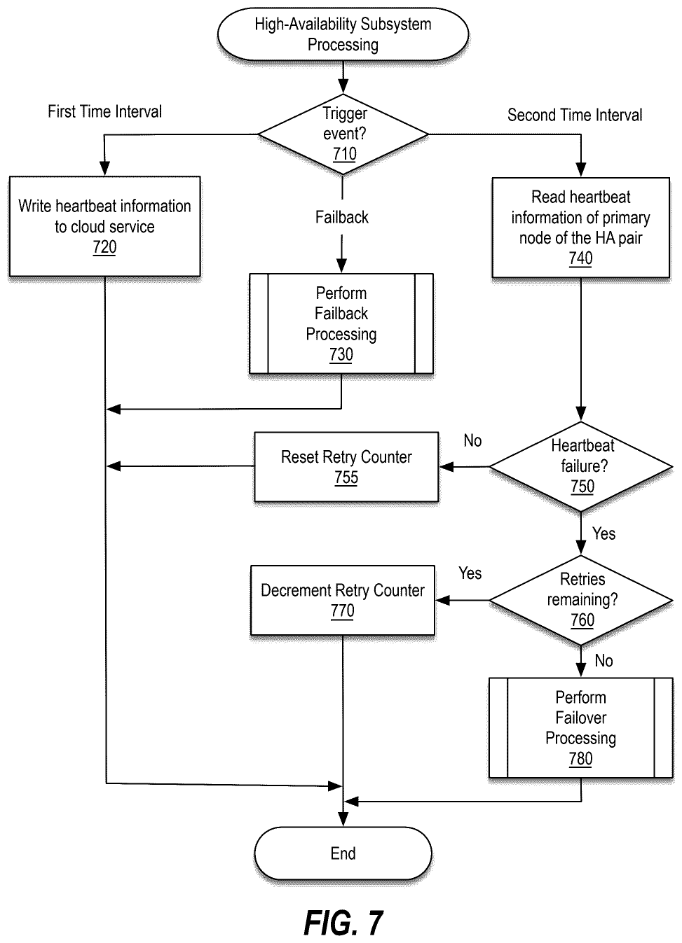

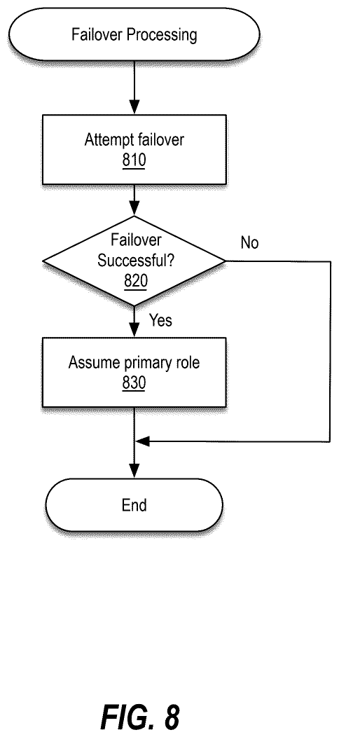

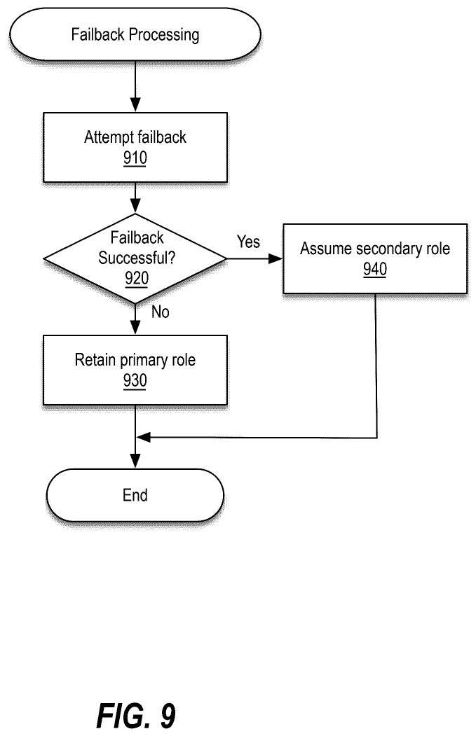

The HA module may be responsible for generating heartbeat information for the HA partner on which it is running, monitoring the health of the other HA partner, and performing failover and failback processing as appropriate. For example, as described further below with reference to FIGS. 7 and 8, a surviving HA partner may take over the role as the primary node from a failed HA partner and serve I/O requests from one or more clients (e.g., clients 105) from the mirror copy of the primary dataset maintained on its storage. Similarly, as described further below with reference to FIGS. 7 and 9, after receiving a manual directive to do so (e.g., from an administrative user of the storage cluster) or in an automated manner (e.g., after a predetermined or configurable amount of time) the surviving partner may attempt to give back to the formerly failed HA partner the role of the primary node for serving I/O requests received from the one or more clients.

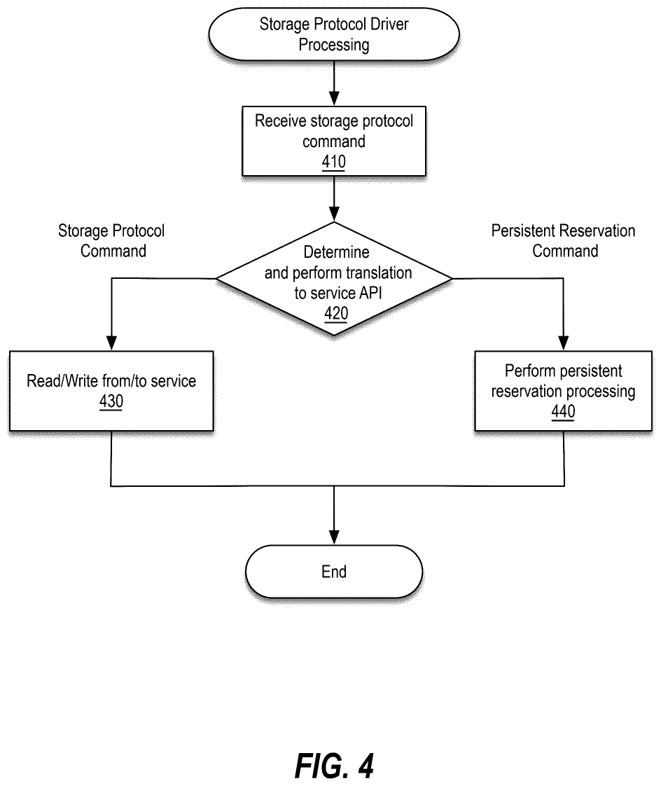

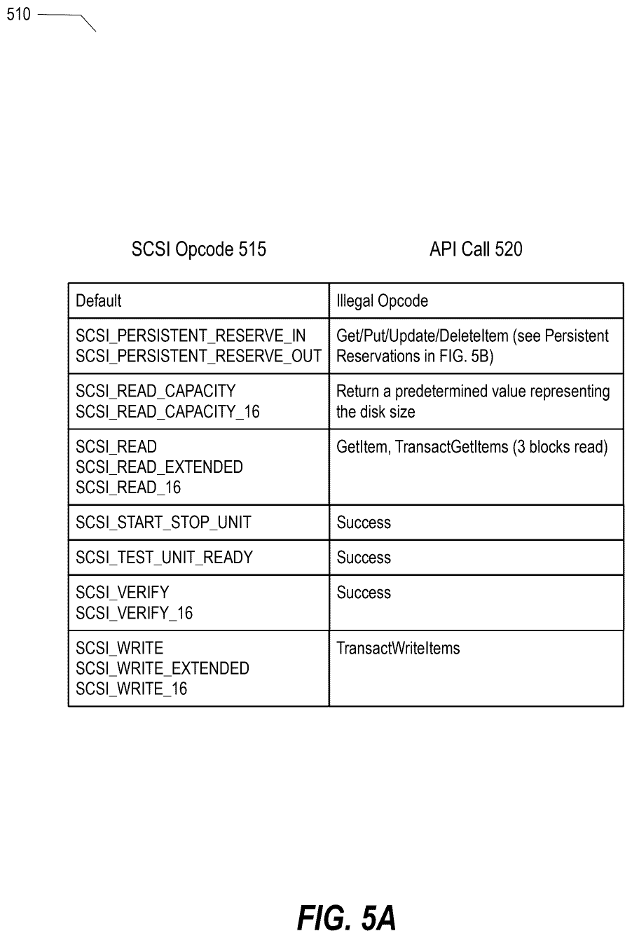

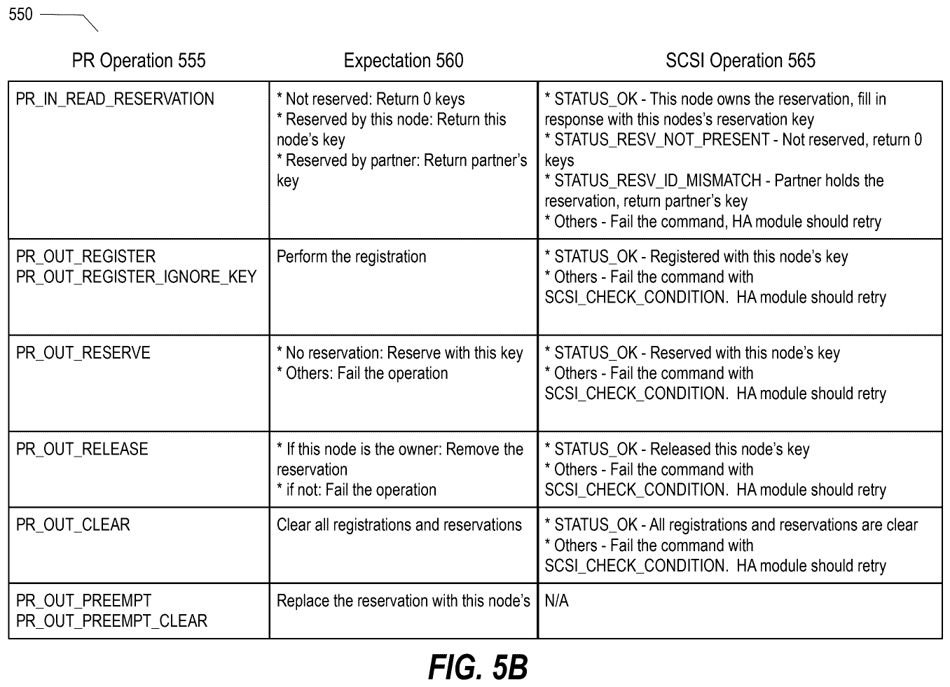

The PHA may be responsible for storing and/or retrieving data from persistent storage on behalf of the HA module. As described further below, in addition to directing the PHA to persist heartbeat information, the HA module may also direct the PHA to persist HA metadata and configuration information to facilitate failover and/or failback processing by the HA partner. In some examples, the PHA may have previously been developed to communicate with a tiebreaker node via a particular storage protocol (e.g., the SCSI protocol) as part of a prior HA mediation approach. In this example, the nodes have been modified to the proposed serverless approach by interposing a translation layer, for example, the storage protocol driver (e.g., a SCSI driver) between the PHA and cloud-native service (e.g., the Amazon DynamoDB or a like service) so as to abstract the underlying mailbox implementation from the PHA. In this manner, a new serverless approach may be used for HA mediation while also avoiding rewriting of the PHA, thereby avoiding potential impact to other potential consumers (not shown) of the PHA, for example, within the storage operating system. For example, as described further below with reference to FIGS. 4 and 5, the storage protocol driver may receive a storage protocol command (e.g., a SCSI protocol command) or a persistent reservation (PR) command and translate the storage protocol command or the PR command to a corresponding method exposed by the service. In this manner, the PHA may still operate as if it is interacting with a SCSI target of a tiebreaker node, but, in fact, the SCSI driver is translating commands output by the PHA into corresponding API methods exposed by the service, thereby allowing the HA mediation functionality previously supported by the tiebreaker node to be replaced with HA mediation functionality provided by the service.

The cloud service module may be responsible for sending requests and receiving responses to/from the cloud-native service 270. For example, the cloud service module may make use of sockets and a secure protocol (e.g., transport layer security (TLS) or kernel TLS (KTLS)) for communicating with the cloud-native service 270. According to one embodiment in which the cloud-native service 270 comprises a database service (e.g., the Amazon DynamoDB), during HA deployment, a database table may be created for use in connection with HA mediation. Additionally, a socket and KTLS may be created using the database service Internet Protocol (IP) address to connect with the database service. Once the connection is created and an upcall is completed, the socket is ready for any sending requests. In one example, when requests are sent to the cloud-native service 270, a receive function (not shown) of the cloud service module will wait for the response, and the receive upcall is triggered once a receive buffer is received. The cloud-native service 270 may use POST for request, and all the data (payload) may be sent and received in the buffer with headers. If the buffer is more than a predetermined or configurable data block size (e.g., 4 KB), the database service may perform multiple sends/receives. Once all the data for a given request is received, the payload is parsed from the receiver buffer, and sent to the caller, which in the context of various examples described herein is the HA module.

As described further below, the storage protocol driver may be responsible for translating storage protocol commands/requests output by the PHA to corresponding API methods (not shown) exposed by the cloud-native service 270. In one embodiment, the storage protocol driver sits below the PHA and translates SCSI commands into dynamoDB API calls, then sends the requests to DynamoDB using the cloud service module functions.

While various examples may be described with reference to the SCSI protocol as an example of a storage protocol, it is to be appreciated, depending on the particular implementation, other storage protocols may be employed including, but not limited to High-Performance Parallel Interface (HIPPI), Advanced Technology Attachment (ATA), Parallel ATA (PATA), Serial ATA (SATA), Serial Attached SCSI (SAS), Nearline SAS (NL-SAS), and/or storage network protocols, non-limiting examples of which include iSCSI, FC, FC over Ethernet (FCoE), NFS, SMB/CIFS, and HTTP.

### Example Disk Creation

As noted above with reference to FIG. 3, in one embodiment, two mailbox disks are created during initial deployment or reboot. Both nodes of the HA pair will create a UUID and try to persist its UUID into the service (e.g., cloud-native service 270). For example, assuming the service represents a database, the nodes may try to persist their respective UUIDs as part of a disk UUID with the condition that the database table has no existing disk UUID. In this example, the UUID that is successfully persisted to the database will be the UUID that both nodes use. In one example, the last part of UUID may be the node system ID. So, a non-limiting example of the UUID may be “disk-mailbox-db-0123456789.” As also noted above, in one embodiment, the two mailbox disks may be distinguished by appending “-1” and “-2” on the end, e.g., disk-mailbox-db-01234567689-1 and disk-mailbox-db-0123456789-2.

In the example depicted in FIG. 6, each node owns one mailbox disk (e.g., mailbox 610a or mailbox 610b). To determine the owner of a given disk, a comparison may be performed to match the sysid from the disk name with the node. For example, by convention in one embodiment, it may be assumed if the sysid matches, the disk with “-1” will be its disk. So, for example, if a node with sysid 0123456789 successfully puts UUID disk-mailbox-db-0123456789 into the cloud database service table (e.g., cloud database service table 620), then disk-mailbox-db-0123456789-1 will be the disk of the node and the other HA partner node will own disk-mailbox-db-0123456789-2.

In one embodiment, after the nodes obtain a UUID to use, both nodes will create two mailbox disks using the UUID and the disks will be added to the nodes.

For SCSI read/write, the disk may be passed back as disk handle, and the disk name and block number may be sent to decide which row in the cloud database service table 620 will be used to read or write. According to one embodiment, SCSI commands are mapped by a SCSI driver (e.g., SCSI driver 260a or 260b) to corresponding API methods exposed by the service used to support HA mediation. For example, assuming a database service (e.g., the Amazon DynamoDB) is used, the SCSI commands will be mapped to corresponding API calls of the database service (e.g., DynamoDB API calls) as described further below.

### Example Node Boot Processing

FIG. 3 is a flow diagram illustrating operations performed by a node of an HA pair of a storage cluster during boot processing in accordance with an embodiment of the present disclosure. The processing described with reference to FIG. 3, may be performed separately by each node (e.g., virtual storage systems 110a-b or nodes 210a-b) of an HA pair during their respective boot processing. In this example, it is assumed two mailbox disks are created for each node during initial deployment or reboot of the node. In general, both nodes will create respective disk UUIDs (e.g., based on their node UUIDs) and try to put them into a service (e.g., cloud-native service 270) used to support HA mediation with the condition that the service has no current disk UUID information stored. As those skilled in the art will appreciate, this creates a race condition between the two nodes of the HA pair and only one of the two nodes of the HA pair will be successful in persisting their created disk UUIDs to the service. The disk UUIDs successfully persisted within the service will be the disk UUIDs that both nodes will use. According to one embodiment, when one or both of the nodes are rebooted, the mailbox disks are removed and are recreated as described below; however, it is assumed the disk UUIDs stored to the service will not be removed during node reboot or shutdown.

At block 310, a secure connection is made to the service. For example, a cloud service module (e.g., cloud service module 250a or 250b) of the node may create an HTTP Secure (HTTPS) socket connection to the service via an internal communication network of a cloud platform (e.g., hyperscaler 120) in which the nodes and service operate. While in various examples described herein, the nodes may be assumed to be virtual storage systems operable in a cloud platform, it is to be noted, the nodes may alternatively be physical on-premises storage solutions that make use of the service to facilitate performance of HA mediation, thereby allowing HA mediation to be performed without reliance on a separate server operating as a tiebreaker At decision block 320, it is determined whether the UUIDs for mailbox disks (e.g., mailbox 280a and mailbox 280b) already exist within the service. If not, processing continues with block 330; otherwise, processing branches to block 340. According to one embodiment, existence of the mailbox disk UUIDs within the service may be determined by retrieving one or both of the disk UUIDs from a cloud database service table. According to one embodiment, the disk UUID for a given mailbox disk may be retrieved from the cloud database service table (if it exists) via a GetItem method call, which may return a DiskInfo field of persistent reservation (PR) data for the mailbox disk at issue. If the mailbox disk UUID has previously been stored to the cloud database service (by the other node of the HA pair), a string representing the mailbox disk UUID may be returned; otherwise, a NULL value or other predetermined or configurable sentinel value may be returned to indicate the requested mailbox disk UUID is empty.

At block 330, two new mailbox disks are created and the node attempts to write its generated mailbox disk UUIDs (e.g., created based on its node system ID) to the service. In one embodiment, the last part of the UUID may represent the node system ID (e.g., disk-mailbox-db-0123456789). In the context of various examples described herein, each node owns one mailbox disk. By convention, the two mailbox disks may have “-1” and “-2,” respectively, appended to the end of the UUID to create a mailbox disk name or mailbox disk UUID. So, in the context of the present example, the mailbox disk of the first node to persist its UUID to the service may have a name of “disk-mailbox-db-0123456789-1” and the mailbox disk of the second node (which failed to persist its UUID to the service) may have a name of “disk-mailbox-db-0123456789-2.” To determine which node is the owner of a given mailbox disk, the system ID (e.g., the numerical portion) from the node UUID may be compared to the corresponding portion of the mailbox disk name or disk UUID. If the system ID portions match, the mailbox disk with “-1” on the end will be its mailbox disk and the mailbox disk with “-2” on the end is owned by the other node. According to one embodiment, the disk UUIDs may be persisted to a cloud database service table via an UpdateItem method call, which will fail if the corresponding disk UUID block is not empty. As such, only one of the two nodes of the HA pair will be successful in persisting their created disk UUIDs to the service.

At block 340, two mailbox disks are created using the existing disk UUIDs. In this scenario, the HA partner node is assumed to have previously persisted its created mailbox disk UUIDs to the service and the node at issue simply makes use of those persisted disk UUIDs. The existing mailbox disk UUIDs may be read from the disk UUID blocks of the respective PR data in the service and the cloud service module of the node at issue may be configured to make use of the existing disk UUIDs to store and/or retrieve information from the service. For example, by convention, the node at issue may make use of the mailbox disk having “-2” at the end of its mailbox disk UUID for performing periodic writes of heartbeat information and may perform periodic reads of heartbeat information written by the HA partner node from the mailbox disk having “-1” at the end of its mailbox disk UUID.

### Example Storage Protocol Driver Processing

FIG. 4 is a high-level flow diagram illustrating operations performed by a storage protocol driver in accordance with an embodiment of the present disclosure. The processing described with reference to FIG. 4, may be performed by one or more of a storage protocol driver (e.g., SCSI driver 260a or 260b) and a cloud service module (e.g., cloud service module 250a or 250b) of a given node (e.g., virtual storage system 110a, virtual storage system 100b, node 210a, or node 210b) of an HA pair during steady state operation (e.g., after completion of boot processing).

At block 410, a storage protocol command is received from a caller (a consumer of the storage protocol driver). For example, in the context of FIG. 2, the storage protocol driver may receive a SCSI command output by a PHA (e.g., PHA 240a or 240b). While the SCSI protocol is used as an example of a particular storage protocol in the context of various embodiments described herein, it is to be appreciate other storage protocols may be used in alternative embodiments.

At decision block 420, a determination is made regarding the appropriate translation to perform to map the storage protocol command to a corresponding method exposed by an API of a service (e.g., cloud-native service 270) used to support HA mediation and the translation is performed. Depending on the particular implementation, the determination may be made by conditional logic expressed in code or via a look-up table. Non-limiting examples of translations from examples of SCSI commands and persistent reservation (PR) commands to examples of methods exposed by the Amazon DynamoDB (a non-limiting example of the service) are provided below with reference to the tables of FIGS. 5A-B. When the received storage protocol command represents a PR command relating to access or use of PR data maintained by the service, for example, setting or retrieval of a mailbox disk UUID and/or otherwise involving persistent locking and/or reservations, processing continues with block 440; otherwise, when the received storage command represents a standard storage command to persist or access a value to or from the service, processing branches to block 430.

At block 430, a read or write (as appropriate) is performed from/to the service by causing the method call generated during block 420 to be invoked via an API exposed by the service. According to one embodiment, the storage protocol driver and cloud service module may cooperate to cause an appropriate HTTPS request to be issued to the service and to wait for and return any response received from the service to the caller (e.g., the PHA).

At block 440, the persistent reservation processing is performed by causing the method call generated during block 420 to be invoked via the API exposed by the service. According to one embodiment, the storage protocol driver and cloud service module may cooperate to cause an appropriate HTTPS request to be issued to the service and to wait for and return any response received from the service to the caller (e.g., the PHA).

### Example SCSI Command to Database Service Call Translations

FIG. 5A is a table 510 showing SCSI command to database service call translations in accordance with an embodiment of the present disclosure. In one embodiment, based on the SCSI opcode 415 (listed in the left-hand column) of the SCSI command output by a PHA (e.g., PHA 240a or PHA 240b) of the node (e.g., virtual storage system 110a, virtual storage system 110b, node 210a, or node 210b), a storage protocol driver (e.g., SCSI driver 260a or 260b) of the node will translate the SCSI command to the corresponding API call 520 (if any-listed in the right-hand column) of a database service (e.g., cloud-native service 270) residing in a cloud platform (e.g., hyperscaler 120) and the API call 520 will be invoked by causing an appropriate HTTPS request to be issued to the database service. Examples of expected behavior for persistent reservation commands (e.g., SCSI_PERSISTENT_RESERVE_IN, SCSI_PERSISTENT_RESERVE_OUT, etc.) are shown in FIG. 5B.

### Examples of Expected Behavior for Persistent Reservation Commands

FIG. 5B is a table 550 showing expected behavior for persistent reservation (PR) commands in accordance with an embodiment of the present disclosure. In one embodiment, based on the PR operation 555 (listed in the left-hand column) associated with the storage protocol command (e.g., SCSI command) output by a PHA (e.g., PHA 240a or PHA 240b) of the node (e.g., virtual storage system 110a, virtual storage system 110b, node 210a, or node 210b), a storage protocol driver (e.g., SCSI driver 260a or 260b) of the node will (conditionally) cause the corresponding action specified in expectation 560 column to be performed via a database service (e.g., cloud-native service 270) residing in a cloud platform (e.g., hyperscaler 120) and will return the corresponding status codes to the caller (e.g., HA module 230a or 230b) as indicated in the SCSI operation 565 column.

### Example Disk Presentation

FIG. 6 is a block diagram 600 conceptually illustrating how mailbox disks are presented to a node of an HA pair in accordance with an embodiment of the present disclosure. According to one embodiment, each HA pair (e.g., node 210a and 210b) has two mailbox disks (e.g., mailbox 610a and 610b). Each mailbox disk may be represented by a predetermined or configurable number of data blocks in a cloud database service table 620 (e.g., a DynamoDB table). In this example, entries of the cloud database service table 620 having a white background are associated with mailbox 610a and entries of the cloud database service table 620 having a gray background are associated with mailbox 610b. While in this example, two mailbox disks are supported by the cloud database service table 620 for each node of a single HA pair, it is to be appreciated an additional cloud database service table (not shown) may be added for each additional HA pair desired to be supported. Alternatively, the cloud database service table 620 may be shared by multiple HA pairs by adding two additional sort keys for each additional HA pair desired to be supported.

In the context of the present example, the cloud database service table 620 is a key-value based database table in which each row (attribute) has two keys, (i) a partition key or block #which may represent the starting logical block address (LBA) for SCSI read/write to retrieve or persist a value (e.g., a 4 KB block of data) from the cloud database service table 620 and (ii) and sort key or node #, which may be the disk name. In this example, some special blocks are also shown in the cloud database service table 620, including, for example, one or more blocks that store PR data, for each mailbox disk, for example, including disk information (e.g., the mailbox disk UUID), a disk reservation entry, and a registration block. These special blocks may be stored at well-known (e.g., predefined and/or configurable block numbers) within the cloud database service table 620.

In one embodiment, there are three PR blocks that store PR data, including one registration block, two reservation blocks, and one block for UUIDs in the cloud database service table 620. In such an embodiment, the registration block and UUIDs block are shared by the nodes of the HA pair and each node has its own reservation block.

In the context of the present example, the heartbeat or liveness information is shown located at block N within the respective mailboxes represented within the cloud database service table 620. As described further below, the lock, which is shown located at block 0 within the respective mailboxes, may be used as part of a failover competition to determine whether a node of an HA pair operating in a role of a secondary node will perform a failover.

### Example Accesses and Operations on the Cloud Database Service Table

In the context of FIG. 6, in order to perform a read, the keys (e.g., disk name and block) and the table name are provided to a database service (e.g., cloud-native service 270) in an HTTPS payload. In some examples, certain conditional checks may be performed before allowing data to be persisted to the cloud database service table 620, which may be presented to the nodes (e.g., virtual storage systems 110a-b or nodes 210a-b) of an HA pair as mailbox disks (e.g., mailbox 610a and mailbox 610b). In one embodiment, for writes, a write may only be allowed if the disk reservation entry (of the PR data) is empty or the disk reservation value is the current owner. In such an embodiment, if the condition does not match, the write will fail.

According to one embodiment, persistent reservations (e.g., SCSI-3 Persistent Reservations) may be used to support the nodes of the HA pair in connection with accessing shared storage (e.g., the cloud database service table 620). In the context of various examples described herein, persistent reservations use the concept of registration and reservation. Participating nodes, each register their own key with the service. After registration, the registered nodes can establish a reservation. In one example, persistent reservations have two commands:
persistent reserve in: Used by the initiator (the node at issue) to read information on the target (the mailbox disk at issue) about existing reservations and registrations.
persistent reserve out: Used by the initiator to register, set and alter its reservations, and break reservations, for example, for error recovery.

The persistent reservation commands may also use subcommands called Service Actions to perform specific functions such as reserving and releasing reservations.

In the context of FIG. 6, reading of the reservation is expected to return the value stored within the reservation block of the PR data.

In the context of FIG. 6, registration is performed by persisting the current node reservation ID into the registration block of the PR data with no condition checking.

In the context of FIG. 6, a reservation may be performed by persisting the current node's reservation ID into the reservation block of the PR data if the registration block of the PR data has the current node's reservation ID stored therein.

In the context of FIG. 6, a release of a reservation may be performed by removing the reservation block entry of the PR data if the reservation block of the PR data has the current node's reservation ID.

In the context of FIG. 6, clearing of existing reservations and registrations may be performed by removing all reservation and registration blocks of the PR data.

### Example HA Subsystem Processing

FIG. 7 is a flow diagram illustrating operations performed by an HA subsystem in accordance with an embodiment of the present disclosure. According to one embodiment, a storage system (e.g., storage cluster 130) operating in a shared-nothing HA configuration includes an HA pair including a first node (e.g., virtual storage system 110a or node 210a) and a second node (e.g., virtual storage system 110b or node 210b). The first node operates in a role of a primary node responsible for serving and storing application data to/from a client of the storage system from a first set of one or more storage media (e.g., hyperscale disks 125a) owned by (assigned to) the first node. The second node operates in a role of a secondary node and maintains a mirror copy of application data on a second set of one or storage media (e.g., hyperscale disks 125b) owned by (assigned to) the second node. The first node periodically writes heartbeat information in accordance with a first time interval (e.g., 0.5, 1.5, 2.5 seconds, etc.) to a service (e.g., cloud-native service 270 operable within a cloud platform (e.g., hyperscaler 120)) that is used to support HA mediation.

The processing described with reference to FIG. 7, may be performed by an HA subsystem (e.g., HA modules 230a and 230b) of the first node and the second node. In the context of the present example, the HA module of a node operating in the role of a primary node, performs the processing associated with blocks 720 and 730, whereas the HA module of a node operating in the role of the secondary node, performs the processing associated with the other blocks. For example, as described further below the second node periodically reads the heartbeat information written by the first node in accordance with a second time interval (e.g., 1, 2, 3 seconds, respectively). Based on the heartbeat information, the second node may evaluate the health status of the first node. When the second node determines the first node has failed, the second node, may perform a failover to assume the primary role in serving access requests to the application data on behalf of the client based on the mirror copy.

At decision block 710, a determination is made by the HA subsystem regarding a trigger event that has initiated execution of the HA subsystem. When the trigger event represents expiration of a first time interval, processing continues with block 720. When the trigger event represents a failback even (e.g., a manually initiated failback or a timer initiated failback), processing continues with block 730. When the trigger event represents expiration of a second time interval, processing branches to block 740.

At block 720, the HA module (when it is associated with a node operating in the role of a primary node) causes heartbeat information to be written to the service. As noted above, the heartbeat information may include a timestamp to allow the secondary node to ascertain the last time at which the primary node was active in writing to the service. Additionally, the primary node may cause additional information (e.g., metadata, HA configuration parameters, and other node state information) to be persisted to the service to facilitate decision making by the secondary node and/or facilitate failover processing.

At block 730, the HA module (when it is associated with a node operating in the role of a primary node) performs failback processing to attempt to cede the primary role back to the HA partner (assuming it has now recovered) that was previously operating in the primary role prior to a failure that caused the node currently operating in the primary node to take over as the primary. A non-limiting example of failback processing is described further below with reference to FIG. 9.

At block 740, the HA module (when it is associated with a node operating in the role of a secondary node) reads the heartbeat information most recently written to the service by the primary node.

At decision block 750, the HA module (when it is associated with a node operating in the role of a secondary node) evaluates the heartbeat information read in block 740 to determine whether a heartbeat failure has occurred. If so, processing continues with decision block 760; otherwise, processing branches to block 755.

At block 755, the HA module (when it is associated with a node operating in the role of a secondary node), resets the retry counter to the retry threshold.

At decision block 760, the HA module (when it is associated with a node operating in the role of a secondary node) determines whether there are any retries remaining before a failover is to be performed. Depending on the particular implementation, a failover may be deferred until a retry threshold number (e.g., 1, 2, 3, etc.) of consecutive heartbeat failures have been detected. If there are retries remaining, processing branches to block 770; otherwise, processing continues with block 780.

At block 770, the HA module (when it is associated with a node operating in the role of a secondary node) decrements the retry counter.

At block 780, the HA module (when it is associated with a node operating in the role of a secondary node) performs failover processing to attempt to assume the primary role. A non-limiting example of failover processing is described further below with reference to FIG. 8.

### Example Failover Processing

FIG. 8 is a high-level flow diagram illustrating operations for performing failover processing in accordance with an embodiment of the present disclosure. The processing described with reference to FIG. 8, may be performed by a node (e.g., virtual storage system 110a, virtual storage system 110b, node 210a, or node 210b) of an HA pair operating in a role of a secondary node. According to one embodiment, there are no substantive changes to the traditional failover workflow. Prior to performing the traditional failover workflow, the secondary node, which is attempting to take over for the primary node, will write its UUID into the primary node's reservation block.

At block 810, the secondary node makes an attempt to take over the primary role. According to one embodiment this involves performing a failover competition. For example, the secondary node may attempt to lock a particular data item one or both mailbox disks (e.g., mailbox disk 610a-b) utilized by the nodes. For example, the failover competition may involve locking one or both of the mailbox disks using the first entry/block (e.g.. the Lock entry depicted in FIG. 6) within a table (e.g., cloud database service table 620) within a service (e.g., cloud-native service 270) that supports HA mediation.

At decision block 820, it is determined whether the failover was successful. If so, processing continues with block 830; otherwise, processing is complete and the secondary node remains in the role of the secondary.

At block 830, the secondary node assumes the primary role.

### Example Failback Processing

FIG. 9 is a high-level flow diagram illustrating operations for performing failback processing in accordance with an embodiment of the present disclosure. The processing described with reference to FIG. 9, may be performed by a node (e.g., virtual storage system 110a, virtual storage system 110b, node 210a, or node 210b) of an HA pair operating in a role of a primary node, that was previously operating in a role of a secondary node and assumed the primary role as a result of performing a failover for a failed primary node. According to one embodiment, there are no substantive changes to the traditional failback workflow. In one example, prior to performing the traditional failback workflow, as the current secondary node is booting up and waiting for failback, the current primary node will clean the current secondary node's reservation block. The current secondary node will boot back up to normal when failback is triggered or waiting for failback is expired.

At block 910, the primary node makes an attempt to cede the primary role back to the former primary node, assuming the former primary node has recovered from the failure that led to the current primary taking over the primary role.

At decision block 920, it is determined whether the failback was successful. If so, processing branches to block 940; otherwise, processing continues with block 930.

At block 930, the primary node retains the primary role. In some examples, failback may be retried at a later time responsive to a subsequent manually initiated failback or responsive to expiration of a failback timer.

At block 940, the primary node assumes the secondary role.

While in the context of the flow diagrams of FIGS. 3, 4A, 5, and 7-9 a number of enumerated blocks are included, it is to be understood that examples may include additional blocks before, after, and/or in between the enumerated blocks. Similarly, in some examples, one or more of the enumerated blocks may be omitted and/or performed in a different order.

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 10 is a block diagram that illustrates a computer system 1000 in which or with which an embodiment of the present disclosure may be implemented. Computer system 1000 may be representative of all or a portion of the computing resources of a physical host on which a virtual storage system (e.g., one of virtual storage systems 110a-b) of a distributed storage system (storage cluster 130) is deployed. Notably, components of computer system 1000 described herein are meant only to exemplify various possibilities. In no way should example computer system 1000 limit the scope of the present disclosure. In the context of the present example, computer system 1000 includes a bus 1002 or other communication mechanism for communicating information, and a processing resource (e.g., a hardware processor 1004) coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, e.g., a magnetic disk, optical disk or flash disk (made of flash memory chips), is provided and coupled to bus 1002 for storing information and instructions.

Computer system 1000 may be coupled via bus 1002 to a display 1012, e.g., a cathode ray tube (CRT), Liquid Crystal Display (LCD), Organic Light-Emitting Diode Display (OLED), Digital Light Processing Display (DLP) or the like, for displaying information to a computer user. An input device 1014, including alphanumeric and other keys, is coupled to bus 1002 for communicating information and command selections to processor 1004. Another type of user input device is cursor control 1016, such as a mouse, a trackball, a trackpad, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Removable storage media 1040 can be any kind of external storage media, including, but not limited to, hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), USB flash drives and the like.

Computer system 1000 may implement the techniques described herein using customized hard-wired logic, one or more ASICs or FPGAs, firmware or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1010. Volatile media includes dynamic memory, such as main memory 1006. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, or stored in storage device 1010, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
periodically writing in accordance with a first time interval, by a first node of a distributed storage system, operating in a role of a primary node, liveness information to a service within a cloud environment, wherein the distributed storage system is operating in a shared-nothing high-availability (HA) configuration, wherein the first node stores application data on behalf of a client of the distributed storage system to a first set of one or more storage media assigned to the first node and a mirror copy of the application data is maintained on a second set of one or more storage media assigned to a second node of the distributed storage system, operating in a role of a secondary node;
periodically reading at a second time interval, by the second node, the liveness information from the service;
determining, by the second node, the first node has failed based on the liveness information read from the service; and
after determining the first node has failed, performing, by the second node, a failover to assume the primary role in serving access requests to the application data on behalf of the client based on the mirror copy.

2. The method of claim 1, wherein performance of the failover involves winning a failover competition by obtaining a lock on a particular data item stored within the service.

3. The method of claim 1, wherein said periodically writing is initiated by an HA module of the first node interacting with a physical host adaptor (PHA) of the first node and performed by a translation layer implemented within the first node that is interposed between the PHA and the service.

4. The method of claim 3, wherein the translation layer is operable to translate commands/requests of a storage protocol output by the PHA to corresponding application programming interface (API) methods exposed by the service.

5. The method of claim 3, wherein the storage protocol comprises Small Computer System Interface (SCSI).

6. The method of claim 1, wherein the distributed storage system comprises a virtual storage system in which nodes of the virtual storage system are implemented in a form of one or more containers, pods, or virtual machines operable within a cloud environment and wherein the service comprises a cloud-native service of the cloud environment.

7. A non-transitory machine readable medium storing instructions, which when executed by one or more processing resources of a distributed storage system, cause the distributed storage system to:
periodically write in accordance with a first time interval, by a first node of the distributed storage system, operating in a role of a primary node, liveness information to a service within a cloud environment, wherein the distributed storage system is operating in a shared-nothing high-availability (HA) configuration, wherein the first node stores application data on behalf of a client of the distributed storage system to a first set of one or more storage media assigned to the first node and a mirror copy of the application data is maintained on a second set of one or more storage media assigned to a second node of the distributed storage system, operating in a role of a secondary node;
periodically read at a second time interval, by the second node, the liveness information from the service;
determine, by the second node, the first node has failed based on the liveness information read from the service; and
after determining the first node has failed, perform, by the second node, a failover to assume the primary role in serving access requests to the application data on behalf of the client based on the mirror copy.

8. The non-transitory machine readable medium of claim 7, wherein performance of the failover involves winning a failover competition by obtaining a lock on a particular data item stored within the service.

9. The non-transitory machine readable medium of claim 7, wherein periodically writing by the first node is initiated by an HA module of the first node interacting with a physical host adaptor (PHA) of the first node and performed by a translation layer implemented within the first node that is interposed between the PHA and the service.

10. The non-transitory machine readable medium of claim 9, wherein the translation layer is operable to translate commands/requests of a storage protocol output by the PHA to corresponding application programming interface (API) methods exposed by the service.

11. The non-transitory machine readable medium of claim 9, wherein the storage protocol comprises Small Computer System Interface (SCSI).

12. The non-transitory machine readable medium of claim 7, wherein the distributed storage system comprises a virtual storage system in which nodes of the virtual storage system are implemented in a form of one or more containers, pods, or virtual machines operable within a cloud environment and wherein the service comprises a cloud-native service of the cloud environment.

13. The non-transitory machine readable medium of claim 12, wherein the cloud-native service comprises a database service.

14. A distributed storage system comprising:
one or more processing resources; and
instructions that when executed by the one or more processing resources cause the distributed storage system to:
periodically write in accordance with a first time interval, by a first node of the distributed storage system, operating in a role of a primary node, liveness information to a service within a cloud environment, wherein the distributed storage system is operating in a shared-nothing high-availability (HA) configuration, wherein the first node stores application data on behalf of a client of the distributed storage system to a first set of one or more storage media assigned to the first node and a mirror copy of the application data is maintained on a second set of one or more storage media assigned to a second node of the distributed storage system, operating in a role of a secondary node;
periodically read at a second time interval, by the second node, the liveness information from the service;
determine, by the second node, the first node has failed based on the liveness information read from the service; and
after determining the first node has failed, perform, by the second node, a failover to assume the primary role in serving access requests to the application data on behalf of the client based on the mirror copy.

15. The distributed storage system of claim 14, wherein performance of the failover involves winning a failover competition by obtaining a lock on a particular data item stored within the service.

16. The distributed storage system of claim 14, wherein periodically writing by the first node is initiated by an HA module of the first node interacting with a physical host adaptor (PHA) of the first node and performed by a translation layer implemented within the first node that is interposed between the PHA and the service.

17. The distributed storage system of claim 16, wherein the translation layer is operable to translate commands/requests of a storage protocol output by the PHA to corresponding application programming interface (API) methods exposed by the service.

18. The distributed storage system of claim 16, wherein the storage protocol comprises Small Computer System Interface (SCSI).

19. The distributed storage system of claim 14, wherein the distributed storage system comprises a virtual storage system in which nodes of the virtual storage system are implemented in a form of one or more containers, pods, or virtual machines operable within a cloud environment and wherein the service comprises a cloud-native service of the cloud environment.

20. The distributed storage system of claim 19, wherein the cloud-native service comprises a database service.

21. A method comprising:
performing high-availability (HA) mediation by a distributed storage system operating in a shared-nothing HA configuration without requiring use of a tiebreaker by:
periodically writing, by a first node of the distributed storage system, operating in a role of a primary node, liveness information to a service within a cloud environment, wherein the first node stores application data on behalf of a client of the distributed storage system to a first set of one or more storage media assigned to the first node and a mirror copy of the application data is maintained on a second set of one or more storage media assigned to a second node of the distributed storage system, operating in a role of a secondary node;
periodically reading, by the second node, the liveness information from the service; and
determining, by the secondary node, the first node has failed based on the liveness information read from the service by the secondary node; and
after determining the first node has failed, performing, by the second node, a failover to assume the primary role in serving access requests to the application data on behalf of the client based on the mirror copy.
